(19) United States
(12) Patent Application Publication
(10) Pub. No.: US 2008/0297827 A1
(43) Pub. Date: Dec. 4, 2008

(54) Image Forming System and Print Job Renewal Management Method

(75) Inventor: Kazumi Murata, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/277,478

(22) Filed: Mar. 24, 2006

(51) Int. Cl. G06F 3/12

(52) U.S. Cl. 358/1.15

(57) ABSTRACT

The invention provides an image forming system in which an image forming apparatus (MFP) is connected to a host device through a network, wherein a command for a processing of print data of a user is accepted, a presence of a print job specifying a storage processing by the user is detected from the command, the print job thus detected is displayed on the host device, the user can select whether the detected print job can be renewed or not, and renewal information of the print job is added and data are transmitted from the host device to the MFP when the renewal of the print job is selected.

### BACKGROUND OF THE INVENTION

1. Field of the Invention

The present invention relates to an image forming system and a print job renewal management method in the same system.

2. Description of the Related Art

In a print processing, generally, a print job such as a private, storage or scheduled print is received from a client PC and print data are held to carry out printing. In such a print job in the print processing, all of print data are stored when they are transmitted, and the print data obtained by partially modifying the stored print data are also stored sequentially as an exactly new print job.

The print data subjected to the partial modification are also stored as the exactly new print job. For this reason, a large number of jobs are generated as a job list. In the case in which a user confirms a print job or deletes the unnecessary print job which has not been modified partially, therefore, a great deal of time and labor for searching the print data by setting, as a standard, a time required for an input to an MFP or for searching the newest print job is generated. Even if a file name is displayed, moreover, the time required for inputting the print data is a portion to be compared, for example, in the case of the same file name. Consequently, a great deal of time and labor for searching the newest print data is generated, which is very inconvenient.

In the case in which data on a network are accessed to carry out printing, the presence of a change in the data is discriminated. It has been proposed that the data related to the change are acquired when the change is carried out (for example, JP-A-2002-278719).

### BRIEF SUMMARY OF THE INVENTION

According to embodiments of the present invention, it is an object to provide an image forming system which devises a renewal management of a print job and a print job renewal management method in the same system.

The present invention may provide an image forming system in which an image forming apparatus (MFP) is connected to a host device through a network comprising:
a driver for controlling a transmission/receipt of data to/from the MFP in the host device,
wherein the driver carries out a control to detect a presence of a print job specifying a processing of storing data, to display, on the host device, the print job thus detected and to select whether the detected print job can be renewed or not.

The MFP includes:
1) a network terminal for transmitting/receiving data to/from the host device;
2) a storage portion for storing data received from the host device and data processed in the MFP;
3) an operating portion for inputting and displaying a set item related to an image formation; and
4) a control portion for developing the data and controlling a print processing, and
the control portion receives data from the host device and executes a processing in accordance with an instruction for renewing the print job in the case of a job specifying the storage processing.

### DESCRIPTION OF THE DRAWINGS

FIG. 1 is a block diagram showing a structure of an image forming system according to an embodiment of the invention.

FIG. 2 is a flowchart showing a flow of a processing of a print job in the image forming system.

FIG. 3 is a flowchart showing the flow of the processing of the print job in the image forming system.

FIG. 4 is a view showing an example of GUI, illustrating a type of a print processing in a driver.

### DETAILED DESCRIPTION OF THE INVENTION

Throughout this description, the embodiments and examples shown should be considered as exemplars, rather than limitations on the apparatus and methods of the present invention.

An embodiment of the invention will be described below with reference to the accompanying drawings. In each of the drawings, the same portions have the same reference numerals.

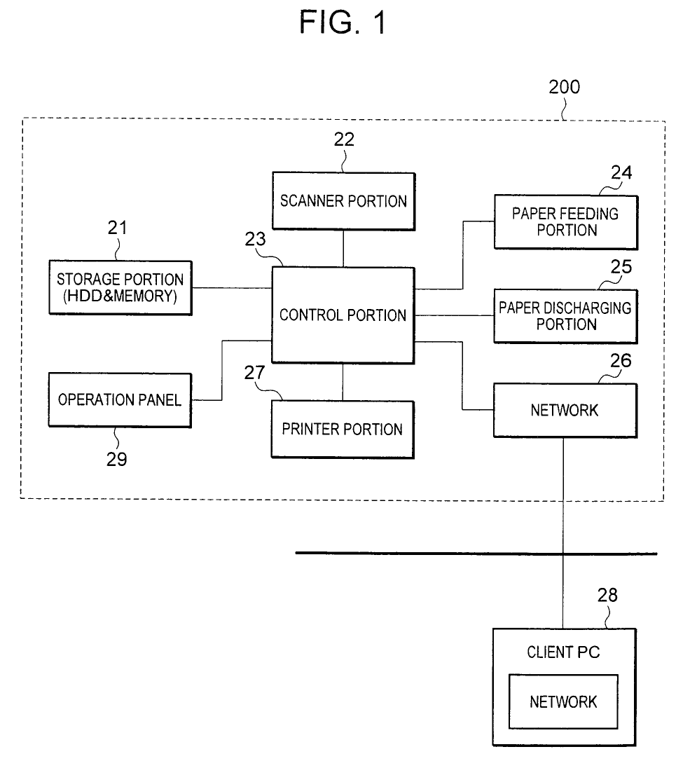

FIG. 1 is a block diagram showing a structure of an image forming system according to the embodiment of the invention.

In FIG. 1, an image forming processing apparatus 200 comprises a communicating portion 26 for transmitting/receiving data and an instruction to/from an outside, and is connected to a client PC 28 through a general purpose network, for example. The image forming processing apparatus 200 is constituted by a storage portion 21 for storing data processed in the apparatus, a control portion 23 for carrying out a control for developing data stored in the storage portion 21 and transferring a processing method, a printer portion 27 for carrying out printing, a scanner portion 22 for reading image data, a paper feeding portion 24 for taking in a print paper specified by a user, a paper discharging portion 25 for discharging a printed matter, and an operation panel 29 for inputting and displaying an operation of the apparatus.

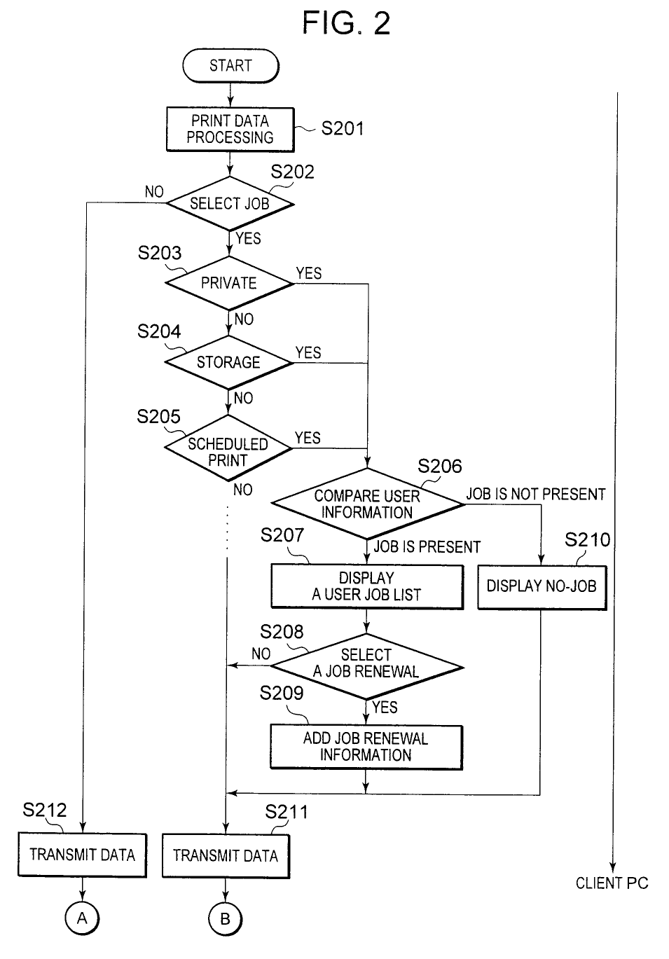

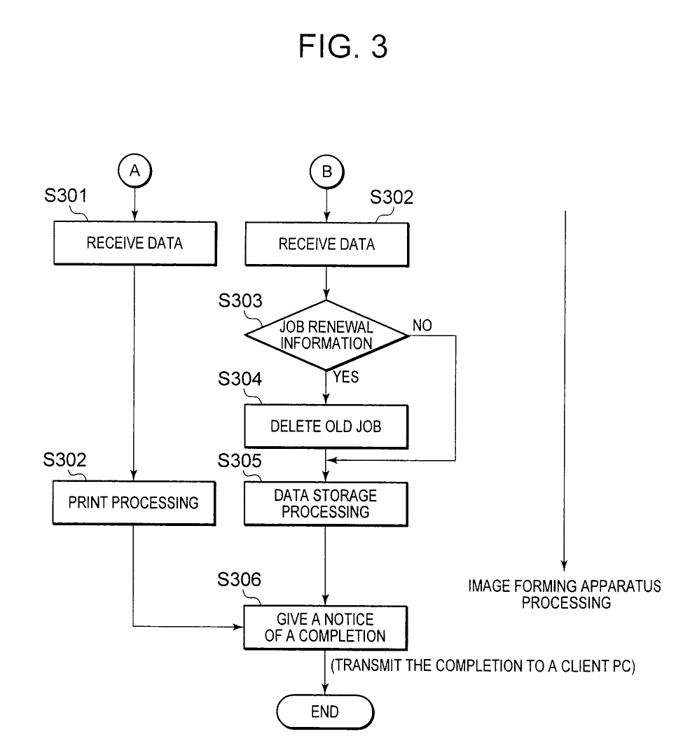

Referring to the flowcharts in FIG. 2 and FIG. 3, next, description will be given to a flow of a processing of a print job in the image forming system. The flowchart in FIG. 2 shows a processing to be carried out by a client PC and the flowchart in FIG. 3 shows a processing to be carried out by an MFP.

In the client PC 28, print data are processed. The print data are set by the driver, thereby carrying out the processing. There are various print processings.

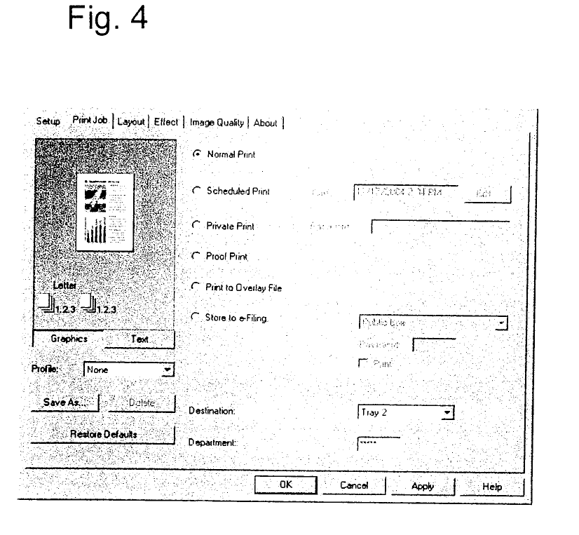

FIG. 4 shows an example of GUI, illustrating a type of the print processing in the driver. When a tab of a job type (Print job) is clicked, the type of the print processing in the driver is displayed. Herein, the following printing types are prepared. Therefore, the user can select any of the types with a button.

### Normal Print:

When this is selected, the completion of a print processing or the receipt of print data is reported to the client PC 28 transmitting data in the processing of the print data.

### Scheduled Print:

This is also referred to as a time designating print, and the printing is carried out at a time designated by the user and the completion of the print processing or the receipt of print data is reported to the client PC 28 transmitting the data.

### Private Print:

When this is selected, the print data are held in the MFP. By the authentication of the user, the completion of the print processing or the receipt of the print data is reported to the client PC 28 transmitting the print data.

### Proof Print:

This is a processing of carrying out printing by way of trial in the execution of the print.

### Print to Overlay File:

The transmitted print data are stored, and the present data are added to the print data and are used as an overlay function.

### Store to Filing:

This is a function of storing the transmitted print data in the MFP body. In the same manner as the storage function, “share”, “group” and “individual” can be designed as a file storage destination. When the print data are stored in the MFP to carry out printing, the user operates a control panel of the MFP.

As shown in FIG. 2, first of all, a print data processing is executed in the client PC (Step S201). The user selects the print type to be executed by the driver in the processing of the print data, that is, a job.

As a next step, therefore, a job to be held in the MFP is selected and a print job which is not held in the MFP is decided (Step S202).

If the print job which is not held in the MFP is selected, the client PC transmits the print data to the MFP (Step S212). The MFP receiving the print data from the client PC (Step S301) carries out a print processing (Step S302). When the print processing is completed, a notice of the completion is transmitted to the client PC (Step S306).

If the job to be held in the MFP is selected, the type of the print processing is subsequently decided. “Private Print”, “Store to Filing” or “Scheduled Print” is decided (Steps S203, S204 and S205). If any of them is decided, user information held currently in the MFP are compared with each other (Step S206). If a job of the user is present, a list of the job of the user is displayed (Step S207). If the job of the user is present, whether a processing of updating the job is carried out is selected and confirmed (Step S208). When the renewal processing is carried out, job renewal information is added to the transmitted data (Step S209) and the same data are transmitted from the client PC 28 to the MFP (Step S211). When the renewal processing is not carried out, the data are transmitted from the client PC 28 to the MFP (Step S211) If the job of the user is not present, “No job” is displayed, for example (Step S210) and the data renewal processing is not carried out but the data are transmitted from the client PC 28 to the MFP (Step S211).

As shown in FIG. 3, the MFP receives the data (Step S302) and then confirms the presence of the job renewal information (Step S303). If the job renewal information is present, a job which has already been present in the MFP is deleted (Step S304) and a processing of storing the received data is carried out (Step S305). When the processing of storing the data on the MFP side is completed, a notice of the completion is transmitted to the client PC (Step S306).

At the Step S208, the list of the job of the user is displayed when whether the job is renewed is selected. If an instruction for printing is received in the same job name, however, an inquiry may be given as to whether the print data are renewed or not. While the job which has already been present in the MFP is deleted at the Step S304, moreover, a comparison of the print data corresponding to the print job may be executed and the renewal of only data in a changed portion may be executed.

According to the invention, it is possible to display, as a list, data stored to be print jobs of individual users, thereby renewing and managing the print job easily. Moreover, the user can select whether the renewal can be carried out or not before and after the comparison of the print data. Therefore, it is possible to enhance the convenience of the user for the renewal and management.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming system in which an image forming apparatus (MFP) is connected to a host device through a network comprising:
a driver for controlling a transmission/receipt of data to/from the MFP in the host device,
wherein the driver carries out a control to detect a presence of a print job specifying a processing of storing data, to display, on the host device, the print job thus detected and to select whether the detected print job can be renewed or not,
the MFP including:
1) a network communicating portion for transmitting/receiving data to/from the host device;
2) a storage portion for storing data received from the host device and data processed in the MFP;
3) an operating portion for inputting and displaying a set item related to an image formation; and
4) a control portion for developing the data and controlling a print processing, and
the control portion receiving data from the host device and executing a processing in accordance with an instruction for renewing the print job in the case of a job specifying the storage processing

2. The image forming system of claim 1, wherein it is possible to select a renewal of the print data or an exact acceptance of a print job without an execution of the renewal of the print data when an instruction for printing is received in the same job name in a decision whether the print job can be renewed or not.

3. The image forming system of claim 1, wherein when the renewal of the print job is selected, renewal information of the print job is added and data are transmitted from the host device to the MFP.

4. The image forming system of claim 1, wherein a comparison of the print data corresponding to the print job is executed and a renewal of only data in a changed portion is executed.

5. The image forming system of claim 1, wherein the MFP deletes an old version of the print job from the storage portion when receiving renewal information of the print job.

6. The image forming system of claim 1, wherein it is possible to select a display of a screen capable of selecting whether the renewal can be carried out or not before an execution of a comparison or a display of a screen capable of selecting whether the renewal can be carried out or not after the execution.

7. The image forming system of claim 1, wherein a print processing is executed in the MFP and a notice of a completion of the processing is transmitted from the MFP to the host device after the completion in the case of a print job in which the storage processing is not specified.

8. The image forming system of any of claims 1 to 7, wherein the host device is a client PC.

9. A method of renewing and managing a print job in an image forming system in which an image forming apparatus (MFP) is connected to a host device through a network, comprising the steps of:
accepting a command for a processing of print data;
detecting a presence of a print job specifying a storage processing from the accepted command;
displaying the detected print job on the host device;
selecting whether the detected print job can be renewed or not; and
adding renewal information of the print job and transmitting data from the host device to the MFP when the renewal of the print job is selected.

10. The method of renewing and managing a print job of claim 9, wherein it is possible to select a renewal of the print data or an exact acceptance of a print job without an execution of the renewal of the print data when an instruction for printing is received in the same job name in a decision whether the print job can be renewed or not.

11. The method of renewing and managing a print job of claim 9, wherein a comparison of the print data corresponding to the print job is executed and a renewal of only data in a changed portion is executed.

12. A renewal and management program of a print job for causing a computer to function as:
command accepting means for accepting a command for a processing of print data;
detecting means for detecting a presence of a print job specifying a storage processing from the accepted command;
display means for displaying the detected print job on a host device;
renewal enable/disable selecting means for freely selecting whether the detected print job can be renewed or not; and
transmitting means for adding renewal information of the print job and transmitting data from the host device to an image forming apparatus (MFP) when the renewal of the print job is selected in order to renew and manage a print job in an image forming system in which the MFP is connected to the host device through a network.

13. The renewal and management program of a print job of claim 12, further comprising:
selecting means capable of selecting a renewal of the print data or an exact acceptance of a print job without an execution of the renewal of the print data when an instruction for printing is received in the same job name in a decision whether the print job can be renewed or not.

14. The renewal and management program of a print job of claim 12, further comprising:
comparing and renewing means for executing a comparison of the print data corresponding to the print job and executing a renewal of only data in a changed portion.
